(19) United States
(12) Patent Application Publication
(10) Pub. No.: US 2023/0329488 A1
(43) Pub. Date: Oct. 19, 2023

(54) CUTTING STATION FOR CUTTING EDIBLE ITEMS

(71) Applicant: OCAA SOLUTIONS LLC, Little Hill, TX (US)

(72) Inventor: Ofuoma ODJE, Little Elm, TX (US)

(21) Appl. No.: 18/151,455

(22) Filed: Jan. 8, 2023

Related U.S. Application Data
(60) Provisional application No. 63/372,882, filed on Apr. 13, 2022.

(51) Int. Cl. A47J 47/00; A47G 11/00

(52) U.S. Cl. CPC A47J 47/005; A47G 11/003

(57) ABSTRACT

Embodiments of the present invention disclose a cutting station for cutting edible items. The cutting station includes a front panel structure, two side panels configured to be coupled with two ends of the front panel structure via a first set of coupling members, and a top panel configured to be mounted over the front panel structure and the two side panels via a second set of coupling members. Further, in an assembled state, the front panel structure, the two side panels and the top panel define a working space, with the working space being accessible to a user from a rear side.

### TECHNICAL FIELD

The present invention generally relates to kitchen-based accessories. More specifically the present invention relates to kitchen-based accessories used for cutting edible items.

### BACKGROUND ART

Edible items such as meat, fruits, and vegetable are generally cut using a chopping board and a knife. Chopping boards may be made up of a variety of materials, such as wood, bamboo, plastic, glass, ceramics, stone, and stainless steel. Additionally, chopping boards are now available in color-coded forms. For example, white chopping boards are considered suitable for bakery and dairy products, yellow chopping boards are considered suitable for cutting cooked meat, brown chopping boards are considered suitable for cutting root vegetables, red chopping boards are considered suitable for cutting raw meat, blue chopping boards are considered suitable for cutting raw fish and green chopping boards are considered suitable for cutting salad, fruits, and fresh vegetables.

Kitchen knives are also available in different varieties, such as paring knives for basic utility work in the kitchen, boning knives for removing meat from bones and cutting fish or poultry, chef's knives used for chopping and slicing fruits and vegetables, carving and slicing knives for slicing meats, bread knives used for cutting loaves of bread, cleavers used for cutting through meat and bones, utility knives for miscellaneous cutting and tomato knives with fine serrations.

However, during the cutting or chopping of the edible items, the fluids stored in the edible items are spread over a large area because of the lack of any protection around the chopping board. Droplets of fluid may be formed and may be spread over a large area as the knife makes an incision in the edible item. Or the fluid may spill onto the table on which the edible item is being cut. The process of chopping or cutting edible items becomes even messier when the edible item is meat as the fluids emanating from the meat may also include blood and disease-causing micro-organisms.

Therefore, there is a need for a device that overcomes the disadvantages and limitations associated with the devices known in the art and provides a more satisfactory solution.

### SUMMARY OF THE INVENTION

According to an aspect of the present invention, there is provided a cutting station for cutting edible items. The cutting station includes a front panel structure, two side panels configured to be coupled with two ends of the front panel structure via a first set of coupling members, and a top panel configured to be mounted over the front panel structure and the two side panels via a second set of coupling members. Further, in an assembled state, the front panel structure, the two side panels and the top panel define a working space, with the working space being accessible to a user from a rear side.

In one embodiment of the invention, the front panel structure includes two front panels disposed at an obtuse angle and coupled using a coupling member.

In one embodiment of the invention, the cutting station further includes a tablecloth configured to be spread on a table, under the front panel structure and the two side panels.

In one embodiment of the invention, the tablecloth is made up of Polyvinyl Chloride (PVC) material.

In one embodiment of the invention, the coupling members are made up of Polyvinyl Chloride (PVC) material.

According to another aspect of the present invention, there is provided a cutting station for cutting edible items. The cutting station includes a front panel structure including two front panels disposed at an obtuse angle and coupled using a coupling member, two side panels configured to be coupled with two ends of the front panel structure via a first set of coupling members, and a top panel configured to be mounted over the front panel structure and the two side panels via a second set of coupling members. Further, in an assembled state, the front panel structure, the two side panels and the top panel define a working space, with the working space being accessible to a user from a rear side.

In one embodiment of the invention, the cutting station further includes a tablecloth configured to be spread on a table, under the front panel structure and the two side panels.

In one embodiment of the invention, the tablecloth is made up of Polyvinyl Chloride (PVC) material.

In one embodiment of the invention, the two front panels, the two side panels, and the top panel are made up of clear acrylic material.

In one embodiment of the invention, the coupling members are made up of Polyvinyl Chloride (PVC) material.

According to another aspect of the present invention, there is provided a cutting station for cutting edible items. The cutting station includes a front panel structure including two front portions disposed at an obtuse angle, two side panels configured to be coupled with two ends of the front panel structure. In an assembled state the front panel structure and the two side panels define a working space, with the working space being accessible to a user from a rear side.

In one embodiment of the invention, the cutting station further includes a top panel configured to be mounted over the front panel structure and the two side panels.

In one embodiment of the invention, the cutting station further includes a plurality of sliders configured to be attached sideways onto the two side panels for height adjustment of the two side panels.

In one embodiment of the invention, the cutting station further includes a plurality of sliders telescopically arranged with the two side panels to slide vertically with respect to the two side panels, for height adjustment of the two side panels.

In one embodiment of the invention, the cutting station further includes a chopping board comprising a front portion, two side portions, and a rear portion, wherein the front portion includes two front surfaces inclined at an obtuse angle to align with the front panel structure, and the two side portions include two respective side surfaces to align with the two side panels.

In one embodiment of the invention, a top surface of the chopping board includes a front slot with two sidearms disposed at an obtuse angle, in the front portion and configured to receive the front panel structure, and two straight slots in the two side portions configured to receive the two side panels, for forming a snap-fit assembly of the chopping board with the front panel structure and the two side panels.

In one embodiment of the invention, the front panel structure and the two side panels are made up of clear acrylic material.

In one embodiment of the invention, the cutting station further includes a tablecloth configured to be spread on a table, under the chopping board.

In one embodiment of the invention, the tablecloth is made up of Polyvinyl Chloride material.

### BRIEF DESCRIPTION OF THE ACCOMPANYING DRAWINGS

The following detailed description of illustrative embodiments is better understood when read in conjunction with the appended drawings. To illustrate the present disclosure, exemplary constructions of the disclosure are shown in the drawings. However, the present disclosure is not limited to a specific device, or a tool and instrumentalities disclosed herein. Moreover, those in the art will understand that the drawings are not to scale.

FIG. 1A illustrates a perspective view of a cutting station for cutting edible items, in accordance with an embodiment of the present invention;

FIG. 1B illustrates an exploded view of the cutting station of FIG. 1A

FIG. 1C illustrates a chopping board of the cutting station of FIG. 1A, in accordance with an embodiment of the present invention;

FIG. 1D illustrates a perspective view of the cutting station for cutting edible items, in accordance with another embodiment of the present invention;

FIG. 1E illustrates an exploded view of the cutting station of FIG. 1C;

FIG. 2 illustrates a cross-section of a coupling member, in accordance with an embodiment of the present invention;

FIG. 3 illustrates a coupling of a front panel, a side panel, and a top panel using a plurality of coupling members; and

FIG. 4 illustrates a coupling between two front panels of a front panel structure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Various embodiments of the present invention provide a cutting station for cutting edible items such as meat, fish, poultry, fruits and vegetables. The cutting station includes a front panel structure. The front panel structure may include two front panels coupled together using a coupling member. The two front panels may be disposed at an obtuse angle. Two side panels are coupled with two edges of the front panel structure using a first set of coupling members. The first set of coupling members may therefore include two coupling members. Further, a top panel is mounted over the front panel structure and the two side panels using a second set of coupling members. The second set of coupling members may therefore include four coupling members, with one coupling member over each one of the two front panels, and the two side panels. In an assembled state the front panel structure, the two side panels, and the top panel define a working space. The working space is a three-dimensional space where the edible items such as meat, fish, poultry, fruits, and vegetables would be placed and cut using a knife. The working space is accessible to a user from a rear side.

The front panel constitutes a forward portion of the cutting station. The two side panels constitute lateral portions of the cutting station. Similarly, the top panel constitutes a top portion of the cutting station. The rear side of the cutting station is kept open and accessible to the user. The front panel structure would therefore prevent the fluid droplets flying in the forward direction to spill over. Similarly, the two side panels would prevent the fluid droplets flying sideways from spilling over and the top panel would prevent the fluid droplets flying in the upwards direction from spilling over. In several embodiments, the cutting station also includes a tablecloth. The tablecloth is supposed to be spread on the table and under the front panel structure and the two side panels. The tablecloth would then be able to collect the fluid droplets emanating from the edible item when the edible item is being cut using a knife.

The coupling member may include a first gripping member, a second gripping member and a neck region. The first gripping member may be configured to receive and secure a first panel, for example the front panel and the second gripping member may be configured to receive and secure a second panel, for example the top panel. The neck region may be configured for flexion allowing the coupling member to flex in an angular range of 0 to 180 degrees. Therefore, the neck region may allow coupling between two orthogonal panels such as between the front panel and the top panel. However, the neck region may also allow coupling between two non-orthogonal panels, such as the two front panels which are disposed at an obtuse angle. Moreover, the two front panels of the front panel structure, the two side panels and the top panel may be made up of clear acrylic material. The tablecloth and the coupling members may be made up of Polyvinyl Chloride (PVC) material. In several embodiments, the coupling members may provide sealed coupling between the front, side and the top panels. However, in several alternate embodiments, wherever necessary, where two panels are coupled to each other using coupling members, the proper sealant material may be applied between the panels, in areas not covered by the coupling members, to prevent any leakage of fluids from in between the panels.

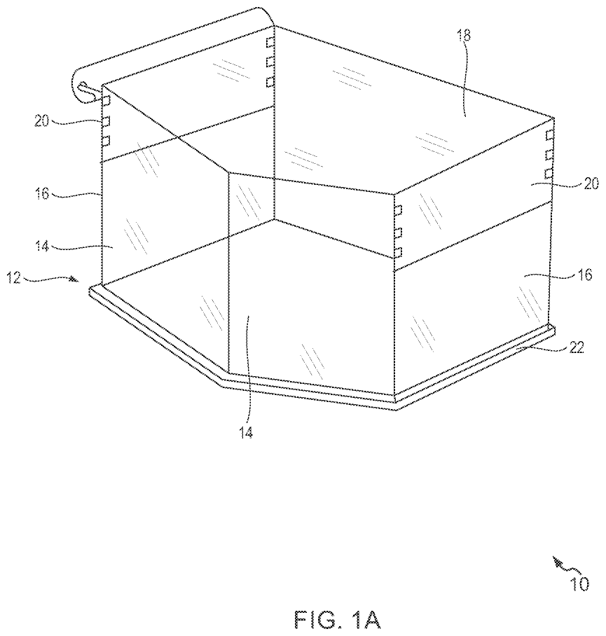

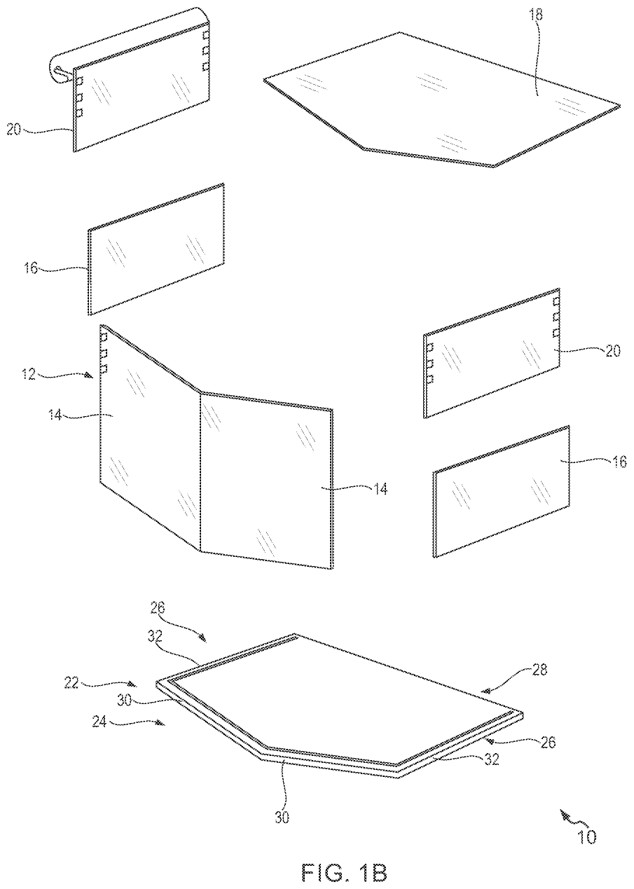

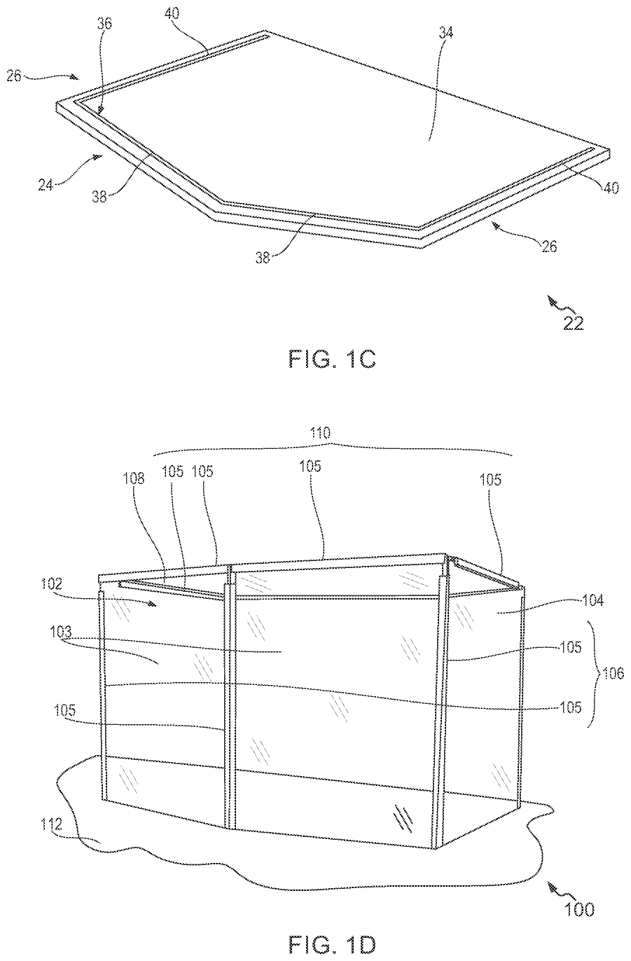

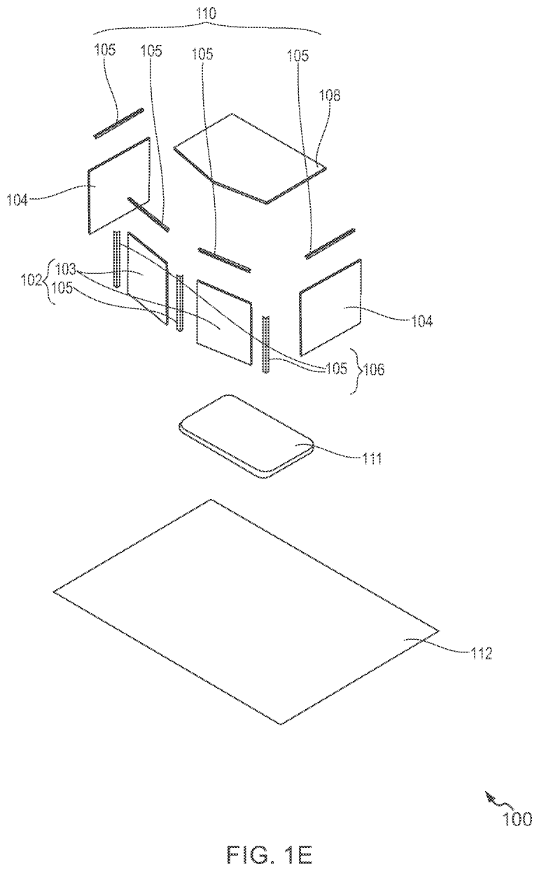

Various example embodiments of the present invention are described hereinafter with reference to FIG. 1A to FIG. 4.

FIG. 1A illustrates a perspective view of a cutting station 10 for cutting edible items, in accordance with an embodiment of the present invention. The cutting station 10 includes a front panel structure 12 disposed in a front portion of the cutting station 10. The front panel structure 12 includes two front panels 14 disposed at an obtuse angle with respect to each other. The two front panels 14 may be coupled to each other using a coupling member (not shown in FIG. 1A) providing a sealed coupling between the two front panels 14. Further, the cutting station 10 includes two side panels 16 configured to be coupled to two ends of the front panel structure 12. The two side panels 16 may be coupled to the two ends of the front panel structure 12 using appropriate coupling members that provide sealed coupling between the front panel structure 12 and the two side panels 16. Moreover, the two front panels 14 are disposed at obtuse angles with the two respective side panels 16 giving the cutting station 10 a boat-like shape. In an assembled state, the front panel structure 12 and the two side panels 16 define a working space that is accessible to a user from the rear side of the cutting station 10. The working space is the space where the edible item would be located and cut using a knife. In several embodiments of the invention, the cutting station 10 also includes a top panel 18. The top panel 18 is configured to be mounted over the front panel structure 12 and the two side panels 16. The top panel 18 may be mounted on top of the front panel structure 12 and the two side panels 16 using a set of coupling members that provide sealed coupling between the top panel 18, the front panel structure 12 and the two side panel 16. The top panel 18 provides covering to the cutting station 10 from the top portion of the cutting station 10.

The cutting station 10 also includes a plurality of sliders 20 for height adjustment of the two side panels 16. In that manner, the plurality of sliders 20 is located on top portions of the two side panels 16. In one embodiment of the invention, the plurality of sliders 20 is configured to be attached sideways onto the two side panels 16, by sliding the plurality of sliders 20 sideways on top of the two side panels 16. In one alternate embodiment of the invention, the plurality of sliders 20 is telescopically arranged with the two side panels 16 and slide vertically with respect to the two side panels 16 for height adjustment of the two side panels 16. The front panel structure 12, the two side panels 16, the top panel 18 and the plurality of sliders 20 may be detached from each other allowing the cutting station 10 to be collapsible for easy storage and handling. In several embodiments of the invention, the front panel structure 12 including the two front panels 14, the two side panels 16, the plurality of sliders 20, and the top panel 18 are made up of clear acrylic material. The cutting station 10 also includes a chopping board 22.

The chopping board 22 may be made up of a variety of materials, such as wood, bamboo, plastic, glass, ceramics, stone, and stainless steel. Additionally, the chopping board 22 may be color coded. For example, white chopping boards are considered suitable for bakery and dairy products, yellow chopping boards are considered suitable for cutting cooked meat, brown chopping boards are considered suitable for cutting root vegetables, red chopping boards are considered suitable for cutting raw meat, blue chopping boards are considered suitable for cutting raw fish and green chopping boards are considered suitable for cutting salad, fruits, and fresh vegetables. The chopping board 22 is also configured to receive the front panel structure 12 and the two side panels 16 in respective slots (not shown in FIG. 1A) arranged for receiving the front panel structure 12 and the two side panels 16 and form a snap-fit arrangement with the front panel structure 12 and the two side panels 16.

FIG. 1B illustrates an exploded view of the cutting station 10 of FIG. 1A. The front panel structure 12 includes two front panels 14. The two side panels 16 are configured to be coupled with two ends of the front panel structure 12. The top panel 18 is configured to be mounted over the front panel structure 12 and the two side panels 16. The plurality of sliders 20 is configured for height adjustment of the two side panels 16. The chopping board 22 includes a front portion 24, two side portions 26, and a rear portion 28. The front portion 24 of the chopping board 22 includes two front surfaces 30. The two front surfaces 30 are inclined with respect to each other at an obtuse angle and therefore align with the two front panels 14 of the front panel structure 12. One of the two front surfaces 30 aligns with one of the two front panels 14 and the other of the two front surfaces 30 aligns with the other of the two front panels 14. The two side portions 26 include two respective side surfaces 32 that align with the two respective side panels 16. Moreover, the two front surfaces 30 are disposed at obtuse angles with the two respective side surfaces 32 giving the chopping board 22 a boat-like shape that forms a snap-fit arrangement with the front panel structure 12 and the two side panels 16.

FIG. 1C illustrates the chopping board 22 of the cutting station 10 of FIG. 1A, in accordance with an embodiment of the present invention. The chopping board 22 also includes a top surface 34. The top surface 34 includes a front slot 36. The front slot 36 includes two sidearms 38 disposed at an obtuse angle with each other, in the front portion 24 of the chopping board 22. The two sidearms 38 are aligned with the two front panels 14 of the front panel structure 12. The front slot 36 by its design is configured to receive the front panel structure 12 to form a snap-fit arrangement with the front panel structure 12. The top surface 34 also includes two straight slots 40, one in each of the two side portions 26 of the chopping board 22. The two straight slots 40 are configured to receive the two side panels 16 to form a snap-fit arrangement with the two straight slots 40 and consequently with the chopping board 22. The two straight slots 40 are disposed at obtuse angles with the front slot 36. The cutting station 10 further includes a tablecloth (not shown in FIG. 1C) configured to be spread on a table under the chopping board 40. The tablecloth would then be able to collect the fluid droplets emanating from the edible item when the edible item is being cut using a knife. In one embodiment of the invention, the tablecloth 42 is made up of Polyvinyl Chloride (PVC) material.

In use, the tablecloth would be spread on the table, and the chopping board 22 would be placed on the tablecloth. The front panel structure 12 would form a snap-fit arrangement with the front slot 36 in the front portion 24 of the chopping board 22, and the two side panels 16 would form a snap-fit arrangement with the two straight slots 40 in the two side portions 26 of the chopping board 22. Optionally, the top panel 18 would be located on top of the front panel structure 12 and the two side panels 16. The edible item would be placed in the working space of the cutting station 10 and cut using a knife. The fluids and other excretions emanating from the edible item would be collected by the tablecloth.

FIG. 1D illustrates a perspective view of a cutting station 100 for cutting edible items, in accordance with another embodiment of the present invention. The cutting station 100 includes a front panel structure 102. The front panel structure 102 constitutes a forward portion of the cutting station 100. In one embodiment of the invention, the front panel structure 102 includes two front panels 103 disposed at an obtuse angle and coupled using a coupling member 105. In another non-limiting embodiment of the invention, the front panel structure 102 may include a single panel. The cutting station 100 further includes two side panels 104 coupled with two ends of the front panel structure 102 via a first set 106 of the coupling members 105. In that regard, the first set 106 of the coupling members 105 may include two coupling members 105, one at each side of the front panel structure 102. The two side panels 104 constitute the lateral portions of the cutting station 100.

The cutting station 100 also includes a top panel 108 configured to be mounted over the front panel structure 102 and the two side panels 104 via a second set 110 of the coupling members 105. In that regard, the second set 110 of the coupling members 105 may include four coupling members 105, with one coupling member 105 over each one of the two front panels 103 and the two side panels 104. The top panel 108 constitutes the top portion of the cutting station 100. In an assembled state, the front panel structure 102, the two side panels 104 and the top panel 108 define a working space. The working space is configured to be accessible to a user from a rear side. The working space is the space where the user may place the edible item, preferably on chopping board and cut the edible item using a knife. The edible item may include fruits, vegetables, breads, poultry, meat and the like. In several embodiments of the invention, the cutting station 100 also includes a tablecloth 112. The tablecloth 112 is configured to be spread on a table, under the front panel structure 102 and the two side panels 104. The chopping board or the edible item is envisaged to be located onto the tablecloth 112.

FIG. 1E illustrates an exploded view of the cutting station 100 of FIG. 1D. FIG. 1E illustrates the front panel structure 102. As mentioned above, the front panel structure 102 includes the two front panels 103 coupled using the coupling member 105. FIG. 1E also illustrates the two side panels 104 and the first set 106 of the coupling members 105. The first set 106 of the coupling members 105 are envisaged to couple the two side panels 104 with two ends of the front panel structure 102. Further illustrated is the top panel 108 and the second set 110 of the coupling members 105. The second set 110 of the coupling members 105 are envisaged to mount the top panel 108 over the front panel structure 102 and the two side panels 104. Also illustrated in FIG. 1E are a chopping board 111 and the tablecloth 112.

In several embodiments of the invention the two front panels 103, the two side panels 104 and the top panel 108 are made up of clear acrylic material. Using acrylic material offer several advantages, such as acrylic has excellent optical clarity and transparency. Further acrylic is highly resistant to variations in temperature. Acrylic can be up to seventeen times more impact resistant when compared with ordinary glass. For the same strength, acrylic is half the weight of glass and ideal for precision machining. Acrylic is highly resistant to many chemicals. Moreover, acrylic is easy to fabricate, shape, clean and maintain.

In several embodiments of the invention, the tablecloth 112, the first set 106 of the coupling members 105, the second set 110 of the coupling members 105 and the coupling member 105 are made up of Polyvinyl Chloride (PVC) material. PVC offers several advantages, such as chemical stability, higher resistance to food borne micro-organisms. PVC can have excellent clarity and transparency. PVC exhibits remarkable durability and strength even under changing temperatures and conditions. PVC is sterilizable and compatible with edible items. PVC also exhibits remarkable resistance to stress cracking. Moreover, PVC is available at relatively low costs.

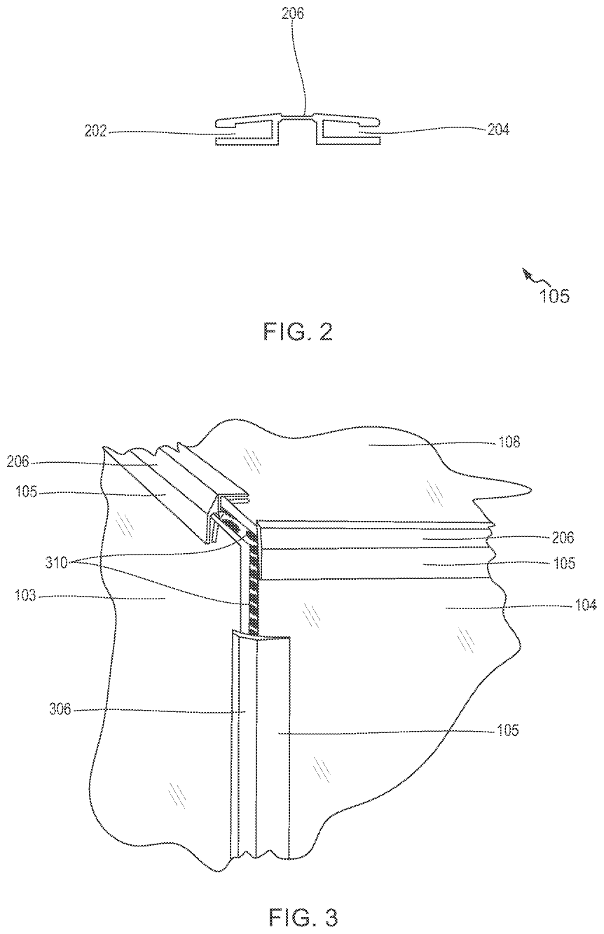

FIG. 2 illustrates a cross-section of the coupling member 105, in accordance with an embodiment of the present invention. The coupling member 105 includes a first gripping member 202, a second gripping member 204, and a neck region 206. The first gripping member 202 is configured to receive a first panel, for example, the front panel 103. The second gripping member 204 is configured to receive a second panel, for example, the top panel 108. The coupling member 105 is configured to flex in the neck region 206. In that manner, even when the front panel 103, and the top panel 108 are orthogonal to each other, a coupling between the two panels may still be established, due to the flexion of the neck region 206.

FIG. 3 illustrates a coupling of the front panel 103, the side panel 104 and the top panel 108 using a plurality of the coupling members 105. As illustrated in FIG. 3, the front panel 103 and the side panel 104 are orthogonal to each other. Further, the top panel 108 is orthogonal to both the front panel 103 and the side panel 104. The coupling between the front panel 103 and the side panel 104 is achieved due to flexion of the neck region 206 of the coupling member 105. Similarly, the coupling between the top panel 108 and the front panel 103, and between the top panel 108 and the side panel 104 is again achieved due to flexion of the neck region 206 of the coupling member 105. In one embodiment of the invention, the coupling members 105 provide sealed coupling between the front panel structure 102, the two side panels 104 and the top panel 108. In alternate embodiments, a sealant 310 has been used in between the front panel 103, the side panel 104, and the top panel 108 in the areas not covered by the coupling members 105. The sealant 310 can be selected from a group consisting of water-based latex, acrylic, butyl, silicone, polyisobutylene, and polyurethane-based sealants.

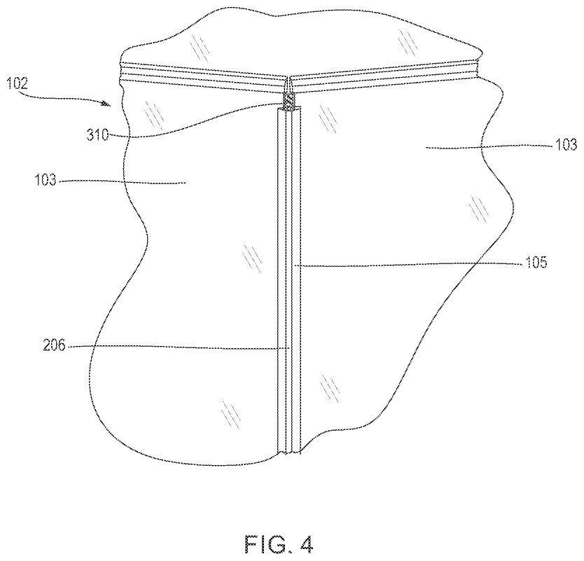

FIG. 4 illustrates a coupling between the two front panels 103 of the front panel structure 102. As illustrated in FIG. 4, the front panels 103 are disposed at an obtuse angle. The coupling between the front panels 103 is achieved due to flexion of the neck region 206 of the coupling member 105. Here, the flexion of the neck region 206 is to a lesser extent that is under 90 degrees. Therefore, the neck region 206 can flex theoretically in the range of 0 degrees to 180 degrees. The flexion of the neck region 206 would therefore direct the angle between two panels. For example, when the two panels are disposed orthogonal to each other, the flexion of the neck region 206 is 90 degrees. When the two panels are disposed at an obtuse angle, the flexion of the neck region 206 would be between 0 and 90 degrees. When the two panels are disposed at an acute angle, the flexion of the neck region 206 would be between 90 and 180 degrees. In one embodiment of the invention, the coupling member 105 provides a sealed coupling between the two front panels 103. In several alternate embodiments, the sealant 310 has been used in between the two front panels 103 in the region not covered by the coupling member 105.

In use, the user would spread the tablecloth 112 on the table. A working space is created by assembling the front panel structure 102 with the two side panels 104 and the top panel 108 over the tablecloth 112. The assembly is carried out in a manner that the two side panels 104 are coupled with the two ends of the front panel structure 102 via the first set 106 of the coupling members 105, and the top panel 108 is mounted over the front panel structure 102 and the two side panels 104 via the second set 110 of the coupling members 105. In one embodiment of the invention, the front panel structure 102 includes the two front panels 103 disposed at an obtuse angle and coupled using the coupling member 105. Wherever necessary, where two panels are coupled to each other using coupling members, proper sealant material 310 may be applied between the panels, in areas not covered by the coupling members, to prevent any leakage of fluids from in between the panels. Preferably, though not bindingly, a chopping board 111 would be located on the tablecloth 112 inside the working space and edible items would be placed on the chopping board before being cut with a knife. The working space created by the front panel structure 102, the two side panels 104, and the top panel 108 would prevent fluids and germs, from the edible items, from spreading outside of the working space.

Various modifications to these embodiments are apparent to those skilled in the art, from the description and the accompanying drawings. The principles associated with the various embodiments described herein may be applied to other embodiments. Therefore, the description is not intended to be limited to the embodiments shown along with the accompanying drawings but is to be providing the broadest scope consistent with the principles and the novel and inventive features disclosed or suggested herein. Accordingly, the invention is anticipated to hold on to all other such alternatives, modifications, and variations that fall within the scope of the present invention and appended claims.

1. A cutting station for cutting edible items, the cutting station comprising:
a front panel structure;
two side panels configured to be coupled with two ends of the front panel structure via a first set of coupling members;
a top panel configured to be mounted over the front panel structure and the two side panels via a second set of coupling members; and
wherein in an assembled state, the front panel structure, the two side panels and the top panel define a working space, with the working space being accessible to a user from a rear side.

2. The cutting station as claimed in claim 1, wherein the front panel structure comprises two front panels disposed at an obtuse angle and coupled using a coupling member.

3. The cutting station as claimed in claim 1, further comprising a tablecloth configured to be spread on a table, under the front panel structure and the two side panels.

4. The cutting station as claimed in claim 3, wherein the tablecloth is made up of Polyvinyl Chloride (PVC) material.

5. The cutting station as claimed in claim 1, wherein the coupling members are made up of Polyvinyl Chloride (PVC) material.

6. A cutting station for cutting edible items, the cutting station comprising:
a front panel structure comprising two front panels disposed at an obtuse angle and coupled using a coupling member;
two side panels configured to be coupled with two ends of the front panel structure via a first set of coupling members;
a top panel configured to be mounted over the front panel structure and the two side panels via a second set of coupling members; and
wherein in an assembled state, the front panel structure, the two side panels and the top panel define a working space, with the working space being accessible to a user from a rear side.

7. The cutting station as claimed in claim 6, further comprising a tablecloth configured to be spread on a table, under the front panel structure and the two side panels.

8. The cutting station as claimed in claim 7, wherein the tablecloth is made up of Polyvinyl Chloride (PVC) material.

9. The cutting station as claimed in claim 6, wherein the two front panels, the two side panels, and the top panel are made up of clear acrylic material.

10. The cutting station as claimed in claim 6, wherein the coupling members are made up of Polyvinyl Chloride (PVC) material.

11. A cutting station for cutting edible items, the cutting station comprising:
a front panel structure comprising two front portions disposed at an obtuse angle;
two side panels configured to be coupled with two ends of the front panel structure; and
wherein in an assembled state the front panel structure and the two side panels define a working space, with the working space being accessible to a user from a rear side.

12. The cutting station as claimed in claim 11, further comprising a top panel configured to be mounted over the front panel structure and the two side panels.

13. The cutting station as claimed in claim 11, further comprising a plurality of sliders configured to be attached sideways onto the two side panels for height adjustment of the two side panels.

14. The cutting station as claimed in claim 11, further comprising a plurality of sliders telescopically arranged with the two side panels to slide vertically with respect to the two side panels, for height adjustment of the two side panels.

15. The cutting station as claimed in claim 11, further comprising a chopping board comprising a front portion, two side portions, and a rear portion, wherein the front portion includes two front surfaces inclined at an obtuse angle to align with the front panel structure, and the two side portions include two respective side surfaces to align with the two side panels.

16. The cutting station as claimed in claim 15, wherein a top surface of the chopping board includes a front slot with two sidearms disposed at an obtuse angle, in the front portion and configured to receive the front panel structure, and two straight slots in the two side portions configured to receive the two side panels, for forming a snap-fit assembly of the chopping board with the front panel structure and the two side panels.

17. The cutting station as claimed in claim 11, wherein the front panel structure and the two side panels are made up of clear acrylic material.

18. The cutting station as claimed in claim 15, further comprising a tablecloth configured to be spread on a table, under the chopping board.

19. The cutting station as claimed in claim 18, wherein the tablecloth is made up of Polyvinyl Chloride material.
